(19) United States
(12) Patent Application Publication
(10) Pub. No.: US 2018/0074450 A1
(43) Pub. Date: Mar. 15, 2018

(54) SHEET PROCESSING APPARATUS AND IMAGE FORMATION SYSTEM

(71) Applicant: Konica Minolta, Inc., Tokyo (JP)

(72) Inventor: Akira TSUNODA, Kanagawa (JP)

(21) Appl. No.: 15/704,736

(22) Filed: Sep. 14, 2017

(30) Foreign Application Priority Data
Sep. 14, 2016 (JP) 2016-179401

(51) Int. Cl. G03G 15/00; B65H 37/00

(52) U.S. Cl. CPC G03G 15/6576; B65H 2801/27; B65H 37/00

(57) ABSTRACT

A sheet processing apparatus includes: a curl correcting section including a conveying member configured to convey a sheet, and a pushing shaft configured to push, toward the conveying member, the sheet conveyed by the conveying member, the curl correcting section being capable of adjusting a correction amount of a curl of the sheet by adjusting a pushing amount of the pushing shaft for pushing the conveying member; and a moving guide section configured to guide the sheet toward a pushing position of the sheet in the conveying member, the moving guide section being configured to move along with a pushing operation of the pushing shaft while maintaining a distance from the pushing shaft at a predetermined distance or smaller such that a conveyance error of the sheet is not caused when the moving guide section guides the sheet.

### CROSS REFERENCE TO RELATED APPLICATIONS

The present invention claims priority under 35 U.S.C. § 119 to Japanese Patent Application No. 2016-179401 filed on Sep. 14, 2016, the entire content of which are incorporated herein by reference.

### BACKGROUND

### Technological Field

The present invention relates to a sheet processing apparatus and an image formation system.

### Description of Related Art

In general, an electrophotographic image forming apparatus (such as a printer, a copy machine, and a fax machine) is configured to irradiate (expose) a charged photoconductor drum (image bearing member) with (to) laser light based on image data to form an electrostatic latent image on the surface of the photoconductor. The electrostatic latent image is then visualized by supplying toner from a developing device to the photoconductor drum on which the electrostatic latent image is formed, whereby a toner image is formed. Further, the toner image is directly or indirectly transferred to a sheet, and then heat and pressure are applied to the sheet at a fixing nip to form a toner image on the sheet.

Such an image forming apparatus causes post-processing errors such as alignment error and loading error in the case where the sheet is curled during sheet conveyance. In particular, in the case of a thin sheet (for example, a sheet of 80 gsm or smaller), the sheet is easily curled, and therefore improvement in the sheet-curl correcting function is desired.

To reduce the occurrence of the above-mentioned post-processing errors of sheets, a technique of correcting the curl of a sheet is known (see, for example, Japanese Patent Application Laid-Open No. 2006-290506). Japanese Patent Application Laid-Open No. 2006-290506 discloses a configuration including a belt member for conveying a sheet and a pushing shaft for pushing the sheet into the belt member. In this technique, by pushing the sheet into the belt member with the pushing shaft, the sheet is bent in a direction opposite to the curling direction of the sheet to correct the curl of the sheet.

### SUMMARY

In some situation, a guide section that guides the sheet toward the area between the belt member and the pushing shaft is provided to correct the curl of the sheet. However, when the pushing shaft moves and the distance between the guide section and the pushing shaft changes, the end of the sheet is caught between the pushing shaft and the guide section, and consequently, conveyance errors may possibly be caused.

An object of the present invention is to provide a sheet processing apparatus and an image formation system which can reduce the occurrence of conveyance errors between the pushing shaft and the guide section.

To achieve the abovementioned object a sheet processing apparatus reflecting one aspect of the present invention includes: a curl correcting section including a conveying member configured to convey a sheet, and a pushing shaft configured to push, toward the conveying member, the sheet conveyed by the conveying member, the curl correcting section being capable of adjusting a correction amount of a curl of the sheet by adjusting a pushing amount of the pushing shaft for pushing the conveying member; and a moving guide section configured to guide the sheet toward a pushing position of the sheet in the conveying member, the moving guide section being configured to move along with a pushing operation of the pushing shaft while maintaining a distance from the pushing shaft at a predetermined distance or smaller such that a conveyance error of the sheet is not caused when the moving guide section guides the sheet.

To achieve the abovementioned object an image formation system reflecting one aspect of the present invention includes: the above-mentioned sheet processing apparatus; and an image forming apparatus configured to introduce, to the sheet processing apparatus, the sheet on which an image is formed.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates a general configuration of an image formation system according to the embodiment;

FIG. 2 illustrates a principal part of a control system of an image forming apparatus according to the embodiment;

FIG. 3 is an enlarged view of a curl correcting section in which the pushing angle is 12°;

FIG. 4 is an enlarged view of a curl correcting section in which the pushing angle is 140°;

FIG. 5 is an enlarged view of a contact area between a pushing shaft and a belt member;

FIG. 6 shows a relationship between a stress application time and a curl correction amount;

FIG. 7 is a perspective view of a sheet pushing section;

FIG. 8A and FIG. 8B illustrate an operation state of the sheet pushing section;

FIG. 9 is an enlarged view of an area around the pushing shaft of the sheet pushing section;

FIG. 10 is an enlarged view of a cam;

FIG. 11 illustrates a sheet pushing section according to a first modification; and

FIG. 12 illustrates a second guide according to a second modification.

### DETAILED DESCRIPTION OF EMBODIMENTS

Hereinafter, one or more embodiments of the present invention will be described with reference to the drawings. However, the scope of the invention is not limited to the disclosed embodiments.

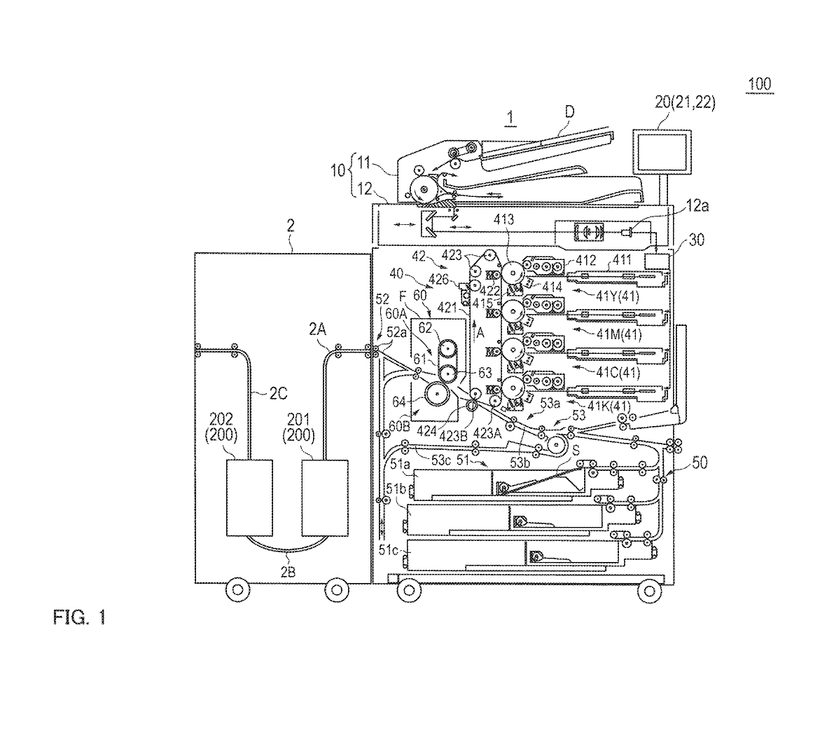

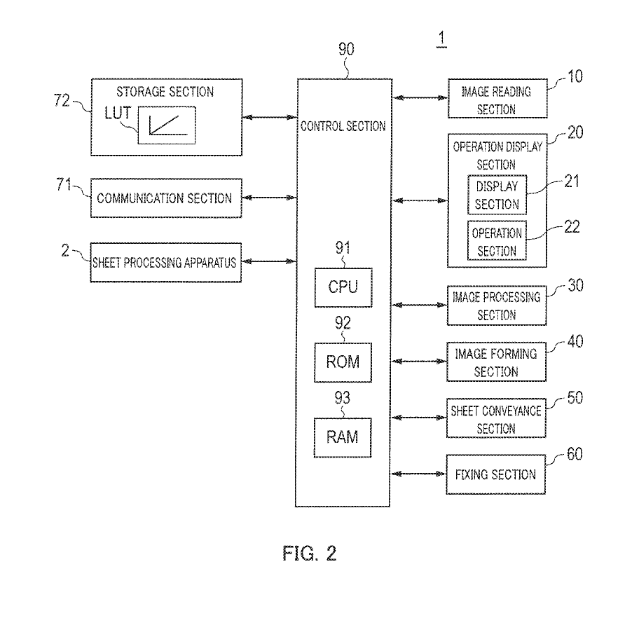

In the following, the present embodiment is described in detail with reference to the drawings. FIG. 1 schematically illustrates a general configuration of image forming system 100 according to the present embodiment. FIG. 2 illustrates a principal part of a control system of image forming apparatus 1 according to the embodiment.

As illustrated in FIG. 1, image formation system 100 is composed of image forming apparatus 1 and sheet processing apparatus 2 which are connected with each other in this order from the upstream side in the conveyance direction of sheet S.

Image forming apparatus 1 illustrated in FIGS. 1 and 2 is a color image forming apparatus of an intermediate transfer system using electrophotographic process technology. That is, image forming apparatus 2 transfers (primary-transfers) toner images of yellow (Y), magenta (M), cyan (C), and black (K) formed on photoconductor drums 413 to intermediate transfer belt 421, and superimposes the toner images of the four colors on one another on intermediate transfer belt 421. Then, image forming system 1 secondary-transfers the resultant image to sheet S, thereby forming an image.

A tandem system is adopted for image forming apparatus 1. In the tandem system, photoconductor drums 413 corresponding to the four colors of YMCK are placed in series in the travelling direction of intermediate transfer belt 421, and the toner images of the four colors are sequentially transferred to intermediate transfer belt 421 in one cycle.

Image forming apparatus 1 includes image reading section 10, operation display section 20, image processing section 30, image forming section 40, sheet conveyance section 50, fixing section 60 and control section 90.

Control section 90 includes central processing unit (CPU) 91, read only memory (ROM) 92, random access memory (RAM) 93 and the like. CPU 91 reads a program suited to processing contents out of ROM 92, develops the program in RAM 93, and integrally controls an operation of each block of image forming apparatus 1 in cooperation with the developed program. At this time, CPU 101 refers to various kinds of data stored in storage section 72. Storage section 72 is composed of, for example, a non-volatile semiconductor memory (so-called flash memory) or a hard disk drive.

Control section 90 transmits and receives various data to and from an external apparatus (for example, a personal computer) connected to a communication network such as a local area network (LAN) or a wide area network (WAN), through communication section 71. Control section 90 receives, for example, image data (input image data) transmitted from the external apparatus, and performs control to form an image on sheet S on the basis of the image data. Communication section 71 is composed of, for example, a communication control card such as a LAN card.

Image reading section 10 includes auto document feeder (ADF) 11, document image scanning device 12 (scanner), and the like.

Auto document feeder 11 causes a conveyance mechanism to feed document D placed on a document tray, and sends out document D to document image scanner 12. Auto document feeder 11 enables images (even both sides thereof) of a large number of documents D placed on the document tray to be successively read at once.

Document image scanner 12 optically scans a document fed from auto document feeder 11 to its contact glass or a document placed on its contact glass, and brings light reflected from the document into an image on the light receiving surface of charge coupled device (CCD) sensor 12a, to thereby read the document image. Image reading section 10 generates input image data on the basis of a reading result provided by document image scanner 12. Image processing section 30 performs predetermined image processing on the input image data.

Operation display section 20 includes, for example, a liquid crystal display (LCD) provided with a touch panel, and functions as display section 21 and operation section 22. Display section 21 displays various operation screens, image conditions, operating statuses of functions, and the like in accordance with display control signals received from control section 90. Operation section 22 includes various operation keys such as numeric keys and a start key, receives various input operations performed by a user, and outputs operation signals to control section 90.

Image processing section 30 includes a circuit that performs a digital image process suited to initial settings or user settings on the input image data, and the like. For example, image processing section 30 performs tone correction on the basis of tone correction data (tone correction table), under the control of control section 90. In addition to the tone correction, image processing section 30 also performs various correction processes such as color correction and shading correction as well as a compression process, on the input image data. Image forming section 40 is controlled on the basis of the image data that has been subjected to these processes.

Image forming section 40 includes: image forming units 41Y, 41M, 41C, and 41K that form images of colored toners of a Y component, an M component, a C component, and a K component on the basis of the input image data; intermediate transfer unit 42; and the like.

Image forming units 41Y, 41M, 41C, and 41K for the Y component, the M component, the C component, and the K component have similar configurations. For ease of illustration and description, common elements are denoted by the same reference signs. Only when elements need to be discriminated from one another, Y, M, C, or K is added to their reference signs. In FIG. 1, reference signs are given to only the elements of image forming unit 41Y for the Y component, and reference signs are omitted for the elements of other image forming units 41M, 41C, and 41K.

Image forming unit 41 includes exposing device 411, developing device 412, photoconductor drum 413, charging device 414, drum cleaning device 415 and the like.

Photoconductor drum 413 is a negative-charging type organic photoconductor (OPC) having photoconductivity in which an undercoat layer (UCL), a charge generation layer (CGL), and charge transport layer (CTL) are sequentially stacked on a peripheral surface of a conductive cylindrical body made of aluminum (aluminum raw pipe), for example.

Charging device 414 causes corona discharge to evenly and negatively charge the surface of photoconductor drum 413 having photoconductivity.

Exposure device 411 is composed of, for example, a semiconductor laser, and configured to irradiate photoconductor drum 413 with laser light corresponding to the image of each color component. The positive charge is generated in the charge generation layer of photoconductor drum 413 and is transported to the surface of the charge transport layer, whereby the surface charge (negative charge) of photoconductor drum 413 is neutralized. An electrostatic latent image of each color component is formed on the surface of photoconductor drum 413 by the potential difference from its surroundings.

Developing device 412 is a developing device of a two-component reverse type, and attaches toners of respective color components to the surface of photoconductor drums 413, and, visualizes the electrostatic latent image to form a toner image. Developing device 412 forms a toner image on the surface of photoconductor drum 413 by supplying the toner included in the developer to photoconductor drum 413.

Drum cleaning device 415 includes a drum cleaning blade that is brought into sliding contact with the surface of photoconductor drum 413, and removes residual toner that remains on the surface of photoconductor drum 413 after the primary transfer.

Intermediate transfer unit 42 includes intermediate transfer belt 421, primary transfer roller 422, a plurality of support rollers 423, secondary transfer roller 424, belt cleaning device 426 and the like.

Intermediate transfer belt 421 is composed of an endless belt, and is stretched around the plurality of support rollers 423 in a loop form. At least one of the plurality of support rollers 423 is composed of a driving roller, and the others are each composed of a driven roller. When driving roller rotates, intermediate transfer belt 421 travels in direction A at a constant speed.

Intermediate transfer belt 421 has conductivity and elasticity, and includes a high resistance layer on the surface thereof. Intermediate transfer belt 421 is driven into rotation by a control signal from control section 90.

Primary transfer rollers 422 are disposed on the inner periphery side of intermediate transfer belt 421 to face photoconductor drums 413 of respective color components. Primary transfer rollers 422 are brought into pressure contact with photoconductor drums 413 with intermediate transfer belt 421 therebetween, whereby a primary transfer nip for transferring a toner image from photoconductor drums 413 to intermediate transfer belt 421 is formed.

Secondary transfer roller 424 is disposed to face backup roller 423B disposed on the downstream side in the belt travelling direction relative to driving roller 423A, at a position on the outer peripheral surface side of intermediate transfer belt 421. Secondary transfer roller 424 is brought into pressure contact with backup roller 423B with intermediate transfer belt 421 therebetween, whereby a secondary transfer nip for transferring a toner image from intermediate transfer belt 421 to sheet S is formed.

Belt cleaning device 426 removes transfer residual toner which remains on the surface of intermediate transfer belt 421 after a secondary transfer.

When intermediate transfer belt 421 passes through the primary transfer nip, the toner images on photoconductor drums 413 are sequentially primary-transferred to intermediate transfer belt 421. To be more specific, a primary transfer bias is applied to primary transfer rollers 422, and an electric charge of the polarity opposite to the polarity of the toner is applied to the rear side, that is, a side of intermediate transfer belt 421 that makes contact with primary transfer rollers 422 whereby the toner image is electrostatically transferred to intermediate transfer belt 421.

Thereafter, when sheet S passes through the secondary transfer nip, the toner image on intermediate transfer belt 421 is secondary-transferred to sheet S. To be more specific, a secondary transfer bias is applied to backup roller 423B, and an electric charge of the polarity identical to the polarity of the toner is applied to the front side, that is, a side of sheet S that makes contact with intermediate transfer belt 421 whereby the toner image is electrostatically transferred to sheet S.

Fixing section 60 includes upper fixing section 60A having a fixing side member disposed on a fixing surface side, that is, a side of the surface on which a toner image is formed, of sheet S, lower fixing section 60B having a rear side supporting member disposed on the rear surface side, that is, a side of the surface opposite to the fixing surface, of sheet S, and the like. The back side supporting member is brought into pressure contact with the fixing side member, whereby a fixing nip for conveying sheet S in a tightly sandwiching manner is formed.

At the fixing nip, fixing section 60 applies heat and pressure to sheet S on which a toner image has been secondary-transferred to fix the toner image on sheet S. Fixing section 60 is disposed as a unit in fixing part F. In addition, fixing part F may be provided with an air-separating unit that blows air to separate sheet S from the fixing side member or the back side supporting member.

Upper side fixing section 60A includes endless fixing belt 61, heating roller 62 and fixing roller 63, which serve as a fixing side member. Fixing belt 61 is installed in a stretched state between heating roller 62 and fixing roller 63.

Heating roller 62 incorporates a heating source (halogen heater) and applies heat to fixing belt 61. The heating source applies heat to heating roller 62, and as a result, fixing belt 61 is heated.

Fixing roller 63 is driven into rotation in clockwise direction by control section 90. When fixing roller 63 rotates, fixing belt 61 and heating roller 62 rotate in the clockwise direction to follow the rotation of fixing roller 63.

Lower fixing section 60B includes pressure roller 64 that is the rear side supporting member. Together with fixing belt 61, pressure roller 64 forms a fixing nip for conveying sheet S in a sandwiching manner. Pressure roller 64 is driven into rotation in the counterclockwise direction by control section 90.

Sheet conveyance section 50 includes sheet feeding section 51, sheet ejection section 52, conveyance path section 53 and the like. Three sheet feed tray units 51a to 51c included in sheet feeding section 51 store sheets S (standard sheets, special sheets) discriminated on the basis of the basis weight, the size, and the like, for each type set in advance.

Conveyance path section 53 includes a plurality of conveying roller pairs including registration rollers pair 53a, normal conveyance path 53b that conveys sheet S through image forming section 40 and fixing section 60 and ejects sheet S out of image forming apparatus 1, and inversion conveyance path 53c that invers sheet S having passed through fixing section 60 and thereafter conveys sheet S again into normal conveyance path 53b on the upstream of image forming section 40. In the case of double-sided printing, a toner image is formed on the front surface of sheet S when sheet S passes through first normal conveyance path 53b, and a toner image is formed on the rear surface of sheet S when sheet S passes through normal conveyance path 53b after passing through invert conveyance path 53c.

Sheets S stored in sheet tray units 51a to 51c are output one by one from the uppermost, and conveyed to image forming section 40 by conveyance path section 53. At this time, the registration roller section in which the pair of registration rollers 53a are arranged corrects skew of sheet S fed thereto, and the conveyance timing is adjusted. Then, in image forming section 40, the toner image on intermediate transfer belt 421 is secondary-transferred to one side of sheet S at one time, and a fixing process is performed in fixing section 60. Sheet S on which an image has been formed is ejected out of the image forming apparatus by sheet ejection section 52 including sheet ejection rollers 52a.

Sheet S ejected from image forming apparatus 1 is conveyed to sheet processing apparatus 2. Sheet processing apparatus 2 includes first conveyance section 2A, second conveyance section 2B, third conveyance section 2C, and curl correcting section 200. Curl correcting section 200 corrects the curl of sheet S, and includes first curl correcting section 201 and second curl correcting section 202.

Under the control of the control section, which is not illustrated in the drawings, in sheet processing apparatus 2, information relating to the curling state of sheet S and the like are transmitted to curl correcting section 200 from control section 90 of image forming apparatus 1. Curl correcting section 200 corrects the curl of sheet S based on the information relating to curling state transmitted from image forming apparatus 1. In addition, the information relating to the curling state of sheet S is information of the basis weight of sheet S, the sheet type of sheet S, the environment around image forming apparatus 1, the fixing temperature in fixing section 60, and the like. In addition, the information relating to the curling state of sheet S may be information determined by the user based on the degree of the curl of sheet S ejected out of the apparatus.

First curl correcting section 201 corrects a curl curved to protrude to a first surface side of sheet S. The first surface side of sheet S is the side on which an image is formed immediately before the sheet is ejected out of image forming apparatus 1.

Second curl correcting section 202 corrects the curl of sheet S curved to protrude to a second surface side of sheet S. The second surface side is the side opposite to the first surface side.

First conveyance section 2A is a path to which sheet S ejected from image forming apparatus 1 is introduced and conveyed toward first curl correcting section 201.

Second conveyance section 2B is a path for conveying sheet S which has passed through first curl correcting section 201 to second curl correcting section 202.

Third conveyance section 2C is a path for ejecting sheet S which has passed through second curl correcting section 202 to the outside of sheet processing apparatus 2.

Sheet S which has been conveyed into sheet processing apparatus 2 is conveyed to first curl correcting section 201 by first conveyance section 2A, and first curl correcting section 201 corrects the curl of sheet S. Sheet S which has passed through first curl correcting section 201 is conveyed to second curl correcting section 202 by second conveyance section 2B, and second curl correcting section 202 corrects the curl of sheet S. Sheet S which has passed through second curl correcting section 202 is ejected out of the apparatus by third conveyance section 2C.

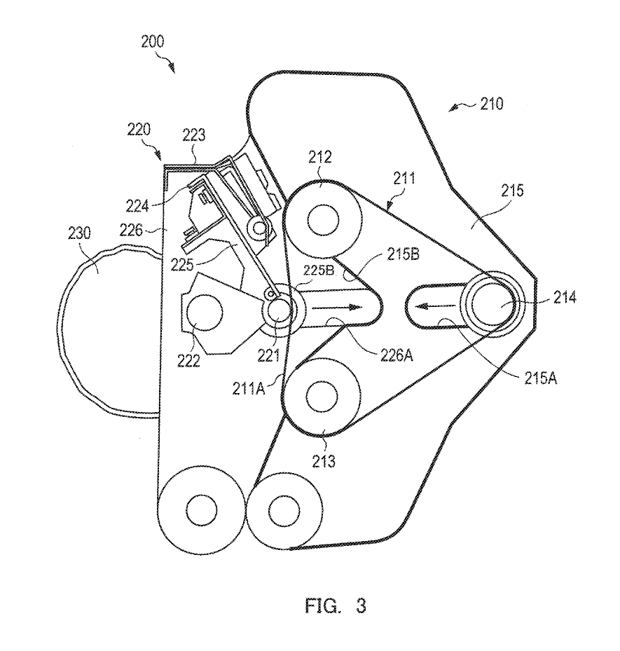

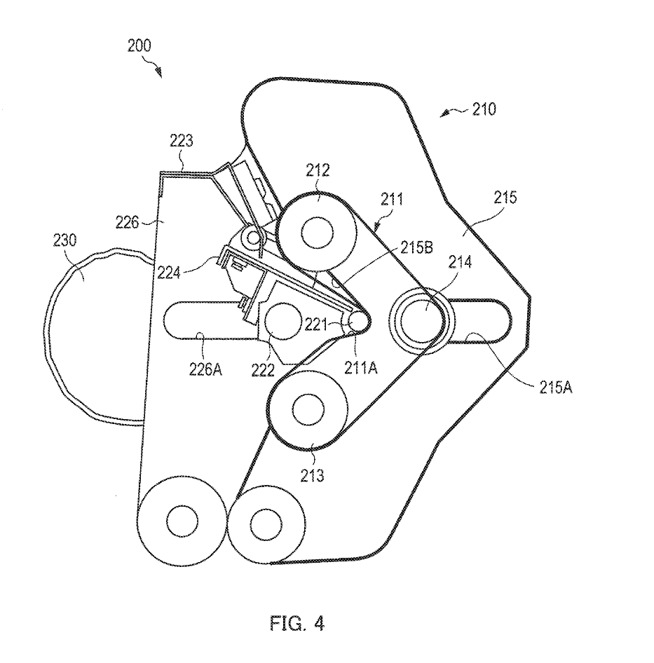

Next, the configuration of curl correcting section 200 is described in detail. FIG. 3 is an enlarged view of curl correcting section 200 in the case of a pushing angle of 12°. FIG. 4 is an enlarged view of curl correcting section 200 in the case of a pushing angle of 140°.

It is to be noted that the configurations of first curl correcting section 201 and second curl correcting section 202 are identical to each other, and therefore first curl correcting section 201 and second curl correcting section 202 are described as curl correcting section 200 in the following description. In addition, FIG. 3 illustrates the installation position of first curl correcting section 201 in FIG. 1, and second curl correcting section 202 has a configuration which is obtained by vertically inverting the configuration of FIG. 3.

As illustrated in FIG. 3, curl correcting section 200 includes belt conveyance section 210, sheet pushing section 220, and cam 230.

Belt conveyance section 210 includes endless belt member 211, first roller 212, second roller 213, third roller 214, and support plate 215. Belt member 211 corresponds to the “conveying member” of the embodiment of the present invention.

Belt member 211 is wound around first roller 212, second roller 213 and third roller 214 in a nearly triangular shape.

First roller 212 and second roller 213 are unmovably supported by support plate 215. Belt member 211 between first roller 212 and second roller 213 is a part where sheet S is conveyed. The distance between first roller 212 and second roller 213 is set to a distance greater than a minimum distance for conveying sheet S by belt member 211.

In addition, the portion of belt member 211 between first roller 212 and second roller 213 is pushed section 211A that is pushed by pushing shaft 221 of sheet pushing section 220. By changing the pushing amount of pushing shaft 221 for pushing pushed section 211A (see FIG. 4), the performance of correcting the curl of sheet S between first roller 212 and second roller 213 is changed.

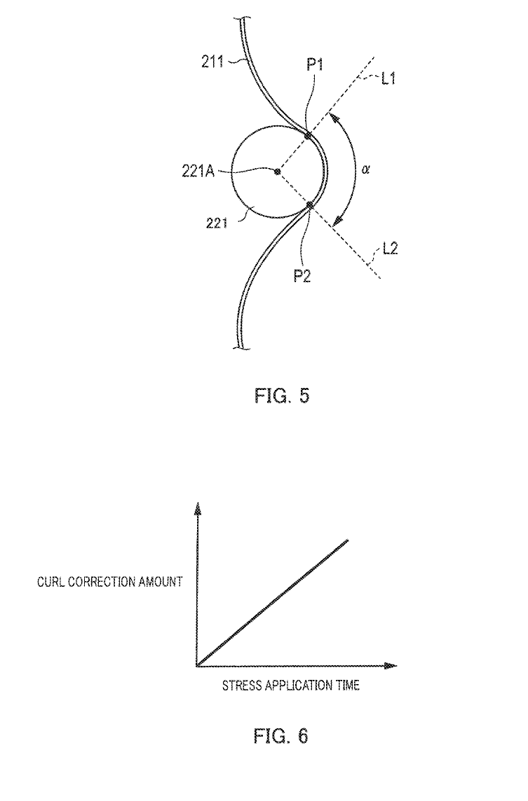

When the pushing amount of pushing shaft 221 for pushing pushed section 211A is changed, the pushing angle of pushing shaft 221 is changed. As illustrated in FIG. 5, the pushing angle is angle α that is defined by lines L1 and L2 passing through center 221A of pushing shaft 221 of sheet pushing section 220, and end portions P1 and P2 of a part where pushing shaft 221 makes contact with the sheet (not illustrated).

As the pushing amount of pushing shaft 221 for pushing belt member 211 increases, the pushing angle increases, and the contact area between pushing shaft 221 and belt member 211 increases. Accordingly, sheet S that passes between pushing shaft 221 and belt member 211 is sandwiched between pushing shaft 221 and belt member 211 for a longer time period. That is, the time period in which sheet S receives a stress from pushing shaft 221 increases.

When correcting the curl of sheet S, a stress is applied in a direction opposite to the direction of the curl of sheet S to correct the curl of sheet S. It is generally known that, as the stress application time increases, the performance of correcting the curl (curl correction amount) is improved as illustrated in FIG. 6, and therefore, the curl correction performance can be improved by increasing the pushing angle of pushing shaft 221. FIG. 3 illustrates curl correcting section 200 in the case where the pushing angle is 12°, and FIG. 4 illustrates curl correcting section 200 in the case where the pushing angle is 140°.

As illustrated in FIG. 3 and FIG. 4, third roller 214 is located on the side opposite to sheet pushing section 220 with respect to pushed section 211A of belt member 211. Third roller 214 is supported such that it can move along long hole 215A that is formed in support plate 215 in parallel to the pushing direction (the horizontal direction in FIG. 3 and FIG. 4) of sheet pushing section 220.

In addition, recess 215B that is recessed to the right side in the drawing is formed between first roller 212 and second roller 213 in support plate 215. With recess 215B, pushing shaft 221 is pushed between first roller 212 and second roller 213.

When pushing shaft 221 is located at the position illustrated in FIG. 3, third roller 214 is located at the right end of long hole 215A, and as belt member 211 is pushed by pushing shaft 221, third roller 214 moves along long hole 215A to the left side so as to be pulled to sheet pushing section 220 side. With this configuration, the entire length of belt member 211 is not changed.

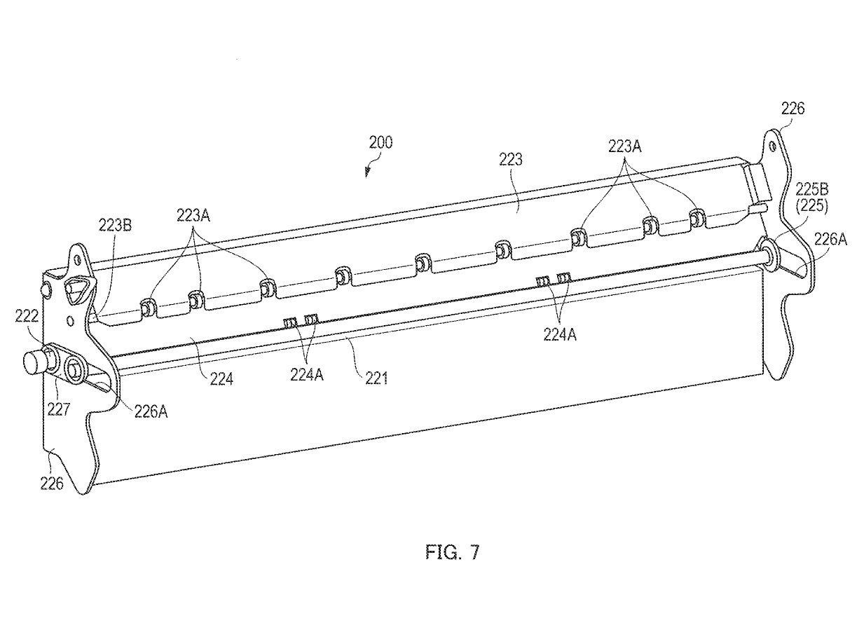

In addition to pushing shaft 221, sheet pushing section 220 includes pressed shaft 222, first guide 223, second guide 224, turning section 225, and supporting section 226. As illustrated in FIG. 7, a pair of supporting sections 226 is provided at both end portions in the axial direction of sheet pushing section 220 to support pushing shaft 221, pressed shaft 222, first guide 223, second guide 224 and turning section 225. First guide 223 corresponds to the “fixed guide section” of the embodiment of the present invention. Second guide 224 corresponds to the “moving guide section” of the embodiment of the present invention.

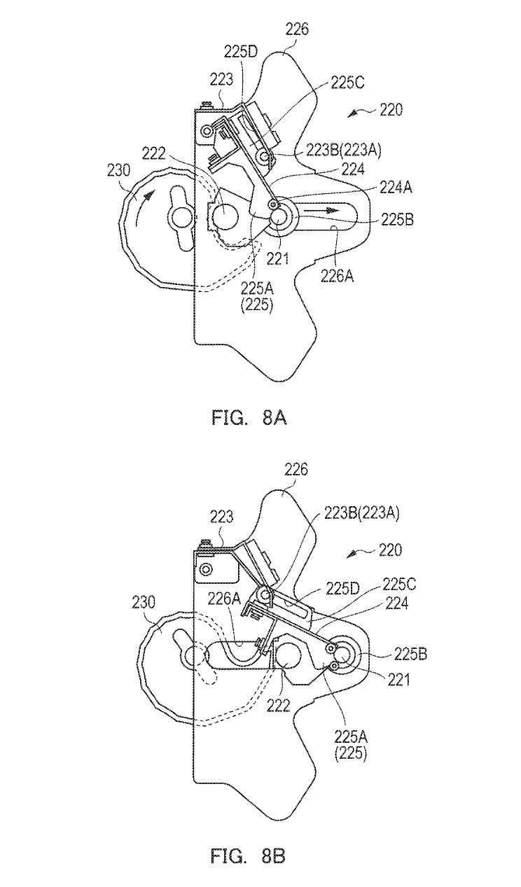

As illustrated in FIG. 8A and FIG. 8B, pressed shaft 222 is a portion that is pressed by cam 230, and is located on the side opposite to belt member 211 with respect to pushing shaft 221. In addition, long hole 226A extending in the pushing direction of pushing shaft 221 (the horizontal direction in the drawing) is formed in supporting section 226.

As illustrated in FIG. 7, pushing shaft 221 and pressed shaft 222 are supported by long hole 226A of supporting section 226, and are connected by connecting section 227 outside supporting section 226. With this configuration, when pressed shaft 222 is pressed by cam 230, pushing shaft 221 moves to push belt member 211.

First guide 223 is fixed at an upper end portion of supporting section 226 on the upstream side of second guide 224 in the conveyance direction of sheet S. First guide 223 guides, to belt member 211 through second guide 224, sheet S introduced in curl correcting section 200.

In the conveyance direction of sheet S, a plurality of conveying rollers 223A are provided on the downstream side of first guide 223. Turning shaft 223B of each conveying roller 223A is pivotally supported by supporting section 226.

Second guide 224 is a plate-shaped guide that is located on the upstream side relative to pushing shaft 221 in the conveyance direction of sheet S. Second guide 224 guides, to the position for pushing sheet S in belt member 211, sheet S guided by first guide 223.

As illustrated in FIG. 8A and FIG. 8B, turning section 225 is provided at both end portions in the axial direction of sheet pushing section 220. Turning section 225 includes main body section 225A where second guide 224 is provided, and ring section 225B where pushing shaft 221 is inserted (see also FIG. 7). It is to be noted that second guide 224 may be fixed to turning section 225, or may be integral with turning section 225.

Turning section 225 turns about pushing shaft 221 with pushing shaft 221 inserted through ring section 225B. That is, second guide 224 turns such that its turning center coincides with the turning center of pushing shaft 221 through turning section 225.

In addition, protruding section 225C protruding from the surface where second guide 224 is provided is provided on both sides of second guide 224 in main body section 225A.

Groove 225D extending in the conveyance direction of sheet S is formed in protruding section 225C. Turning shaft 223B of conveying roller 223A is inserted through groove 225D. With this configuration, turning section 225 moves with respect to turning shaft 223B. In addition, when pushing shaft 221 is located on the leftmost side, turning shaft 223B is located at the downstream end of groove 225D in the conveyance direction of sheet S.

When pushing shaft 221 moves rightward, turning section 225 turns about pushing shaft 221, and turning shaft 223B relatively moves to the upstream end side of groove 225D with respect to turning section 225.

That is, when turning section 225, that is, second guide 224, turns along with pushing shaft 221, the inclination angle of second guide 224 to the horizontal direction changes. More specifically, as the pushing amount of pushing shaft 221 for pushing belt member 211 increases, the inclination angle of second guide 224 decreases.

In the case of the configuration in which the inclination angle of the second guide is not changed, as the pushing shaft is pushed into the belt member, the second guide is brought close to the belt member, and consequently the second guide can possibly interfere with the belt member. However, in the present embodiment, as the pushing amount of pushing shaft 221 increases, the inclination angle of second guide 224 decreases, and accordingly second guide 224 moves such that second guide 224 does not interfere with belt member 211. As a result, sheet S can be easily guided between pushing shaft 221 and belt member 211.

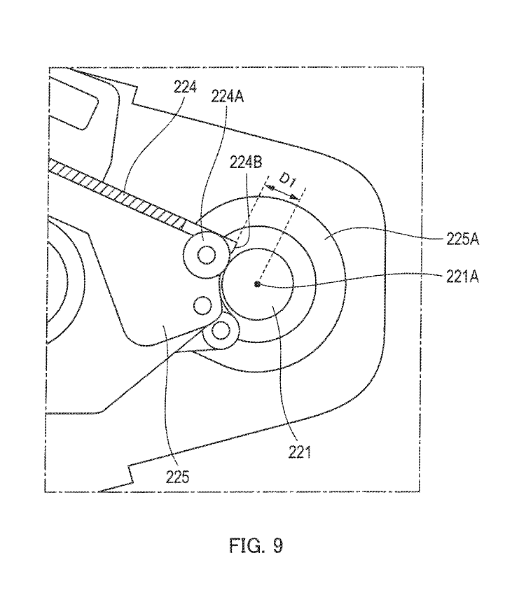

In addition, since second guide 224 turns about center 221A of pushing shaft 221, distance D1 between center 221A of pushing shaft 221 and end surface 224B of the end portion of second guide 224 that is opposite to pushing shaft 221 can be maintained at a predetermined distance at all times as illustrated in FIG. 9. That is, second guide 224 moves along with the pushing operation of pushing shaft 221 while maintaining the distance from pushing shaft 221 at a predetermined distance. The predetermined distance is a distance which does not allow for entrance of sheet S, that is, a distance which does not cause conveyance errors of sheet S, and is set to 0.5 mm, for example.

Here, in the case of the configuration in which second guide 224 does not move, the distance between the end portion of second guide 224 and center 221A of pushing shaft 221 changes when pushing shaft 221 moves. Consequently, the end of sheet S may possibly be caught between second guide 224 and pushing shaft 221, thus causing conveyance errors. In the present embodiment, in contrast, distance D1 between the end portion of second guide 224 and center 221A of pushing shaft 221 is constant at all times, and the end of sheet S does not caught between second guide 224 and pushing shaft 221, and thus, occurrence of conveyance errors between second guide 224 and pushing shaft 221 can be reduced.

In addition, since second guide 224 moves with respect to turning shaft 223B of conveying rollers 223A located at the downstream end of first guide 223, second guide 224 moves forward and backward from the downstream end of first guide 223. Therefore, the guiding distance of sheet S with second guide 224 changes in accordance with the pushing amount of pushing shaft 221.

Here, when the pushing amount of pushing shaft 221 changes, the distance of belt member 211 between first roller 212 and second roller 213, that is, the conveyance length of sheet S, changes. In the present embodiment, second guide 224 moves forward and backward from the downstream end of first guide 223 in accordance with the pushing amount of pushing shaft 221. As a result, the guiding distance of sheet S with second guide 224 can be adjusted in accordance with the variation of the conveyance length of sheet S, and the space below first guide 223 can be effectively utilized as the movement space of second guide 224.

In addition, sliding roller 224A is provided at the end portion of second guide 224. Sliding roller 224A is in contact with pushing shaft 221. With this configuration, sliding roller 224A rotates on the peripheral surface of pushing shaft 221 when second guide 224 turns. With this configuration, the smoothness of turning of second guide 224 can be increased. Sliding roller 224A corresponds to the “sliding member” of the embodiment of the present invention.

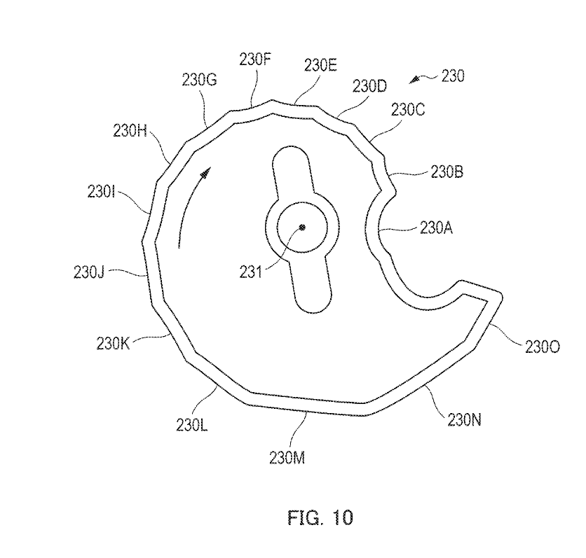

As illustrated in FIG. 10, cam 230 includes pressing surfaces 230A, 230B, 230C, 230D, 230E, 230F, 230G, 230H, 230I, 230J, 230K, 230L, 230M, 230N, and 230O which have different distances from rotation center 231. When cam 230 rotates, pressing surfaces 230A, 230B, 230C, 230D, 230E, 230F, 230G, 230H, 230I, 230J, 230K, 230L, 230M, 230N, and 230O make contact with pressed shaft 222 in this order, and the distances thereof from rotation center 231 increase in this order.

The pushing amount of pushing shaft 221 can be changed in multiple levels by pressing, against pressed shaft 222, pressing surfaces 230A, 230B, 230C, 230D, 230E, 230F, 230G, 230H, 230I, 230J, 230K, 230L, 230M, 230N, 230O of cam 230 having the above-mentioned configuration.

In the present embodiment, the pushing amount of pushing shaft 221 can be changed with cam 230 in sixteen levels in each of first curl correcting section 201 and second curl correcting section 202. That is, in total, the pushing amount of pushing shaft 221 can be changed in 32 levels for the first surface and the second surface of sheet S. Table 1 shows pushing angles corresponding to the basis weight of sheet S and the curl adjusting value. The curl adjusting value is a value that means that as the absolute value of pushing shaft 221 increases, the pushing amount of pushing shaft 221 increases. In addition, the curl adjusting values of “+” correspond to the case where first curl correcting section 201 corrects the curl, and the curl adjusting values of “−” correspond to the case where second curl correcting section 202 corrects the curl.

TABLE 1

| Curl | Basis weight of sheet (gsm) | | | |
|---|---|---|---|---|
| adjusting | 40 to | 92 to | 177 to | 257 or |
| value | 91 | 176 | 256 | greater |
| +16 | 140 | 116 | 78 | 60 |
| +15 | 132 | 108 | 72 | 60 |
| +14 | 124 | 100 | 72 | 54 |
| +13 | 116 | 92 | 66 | 54 |
| +12 | 108 | 84 | 66 | 48 |
| +11 | 100 | 78 | 60 | 48 |
| +10 | 92 | 72 | 54 | 42 |
| +9 | 84 | 66 | 48 | 42 |
| +8 | 78 | 60 | 48 | 36 |
| +7 | 72 | 54 | 42 | 36 |
| +6 | 66 | 48 | 36 | 30 |
| +5 | 60 | 42 | 36 | 30 |
| +4 | 54 | 36 | 30 | 24 |
| +3 | 48 | 30 | 24 | 24 |
| +2 | 42 | 24 | 24 | 18 |
| +1 | 36 | 18 | 18 | 18 |
| 0 | 12 | 12 | 12 | 12 |
| −1 | 36 | 18 | 18 | 18 |
| −2 | 42 | 24 | 24 | 18 |
| −3 | 48 | 30 | 24 | 24 |
| −4 | 54 | 36 | 30 | 24 |
| −5 | 60 | 42 | 36 | 30 |
| −6 | 66 | 48 | 36 | 30 |
| −7 | 72 | 54 | 42 | 36 |
| −8 | 78 | 60 | 48 | 36 |
| −9 | 84 | 66 | 48 | 42 |
| −10 | 92 | 72 | 54 | 42 |
| −11 | 100 | 78 | 60 | 48 |
| −12 | 108 | 84 | 66 | 48 |
| −13 | 116 | 92 | 66 | 54 |
| −14 | 124 | 100 | 72 | 54 |
| −15 | 132 | 108 | 72 | 60 |
| −16 | 140 | 116 | 78 | 60 |

By specifically setting the required pushing angle based on the basis weight of sheet S as shown in Table 1, suitable curl correction of sheet S can be performed. It is to be noted that, in Table 1, the pushing angle decreases as the basis weight of sheet S increases even when the pushing amount is not changed. The reason for this is that the contact area between pushing shaft 221 and sheet S decreases as the thickness of sheet S increases.

With sheet processing apparatus 2 having the above-mentioned configuration, the following effects can be obtained. Second guide 224 moves along with the pushing operation of pushing shaft 221 while maintaining the distance from pushing shaft 221 at a predetermined distance, and thus it is possible to reduce the situation where the end of sheet S is caught between pushing shaft 221 and second guide 224. As a result, occurrence of conveyance errors of sheet S between pushing shaft 221 and second guide 224 can be reduced.

Since second guide 224 moves such that second guide 224 does not interfere with belt member 211, ease of guiding sheet S between pushing shaft 221 and belt member 211 can be increased.

In addition, since second guide 224 is provided with sliding roller 224A, the smoothness of the turning of second guide 224 can be ensured.

In addition, since sheet S is guided to second guide 224 with first guide 223 fixed to supporting section 226, sheet S introduced in curl correcting section 200 can be smoothly guided to the pushing position of belt member 211.

In addition, since conveying roller 223A is provided between first guide 223 and second guide 224, damaging of sheet S at the time when sheet S moves from first guide 223 to second guide 224 can be reduced.

In addition, since second guide 224 moves forward and backward from the downstream end of first guide 223 in accordance with the pushing amount of pushing shaft 221, the guiding distance of sheet S in second guide 224 can be adjusted in accordance with variation in conveyance length of sheet S, and the space below first guide 223 can be effectively utilized as the movement space of second guide 224.

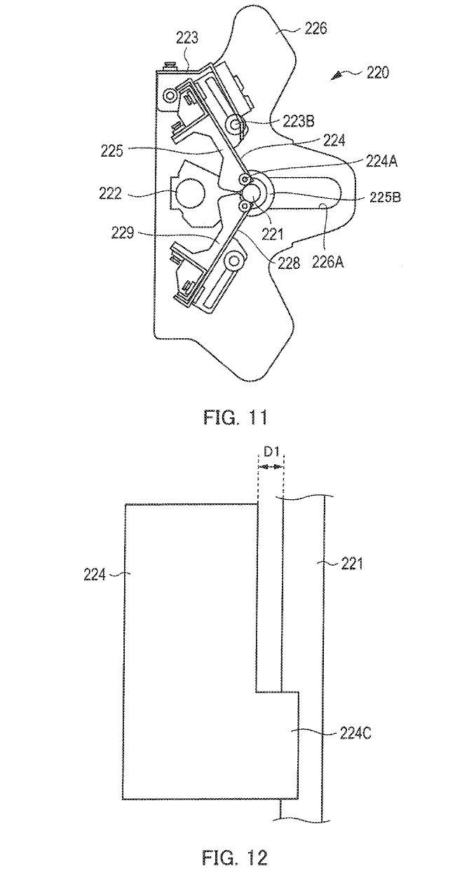

While second guide 224 is disposed only on the upstream side relative to pushing shaft 221 in the conveyance direction of sheet S in the present embodiment, the present invention is not limited to this. For example, as illustrated in FIG. 11, in addition to second guide 224 on the upstream side relative to pushing shaft 221 in the conveyance direction of sheet S, third guide 228 may be provided on the downstream side in the conveyance direction of sheet S. Third guide 228 corresponds to the “downstream side moving guide section” of the embodiment of the present invention.

Third guide 228 is provided in turning section 229 that has a configuration substantially similar to that of turning section 225 of second guide 224. Third guide 228 turns along with pushing shaft 221. With third guide 228, sheet S which has passed through the pushing position of belt member 211 can be smoothly conveyed.

In addition, for example, when sheet S having a relatively large basis weight is used, the sheet S may possibly wound around pushing shaft 221 with the stiffness of sheet S, thus reading to conveyance errors. When third guide 228 is provided on the downstream side as in the configuration illustrated in FIG. 11, however, sheet S is guided by third guide 228 and conveyed without being wound around pushing shaft 221. That is, with the configuration illustrated in FIG. 11, occurrence of conveyance errors due to the wounding of sheet S around pushing shaft 221 can be reduced.

In addition, while the distance between the end portion of second guide 224 and pushing shaft 221 is not changed in the entire axis direction, the present invention is not limited to this. For example, as illustrated in FIG. 12, second guide 224 may have protruding section 224C protruding from a part of the end portion of second guide 224. In the case where such a configuration is employed, it is preferable to dispose second guide 224 such that pushing shaft 221 is located on the depth side relative to second guide 224 in FIG. 12 so that protruding section 224C does not interfere with pushing shaft 221 even when second guide 224 turns.

The embodiments disclosed herein are merely exemplifications and should not be considered as limitative. While the invention made by the present inventor has been specifically described based on the preferred embodiments, it is not intended to limit the present invention to the above-mentioned preferred embodiments but the present invention may be further modified within the scope and spirit of the invention defined by the appended claims.

The present invention is applicable to an image forming system composed of a plurality of units including an image forming apparatus. The units include, for example, a post-processing apparatus, an external apparatus such as a control apparatus connected with a network, and the like.

Although embodiments of the present invention have been described and illustrated in detail, it is clearly understood that the same is by way of illustration and example only and not limitation, the scope of the present invention should be interpreted by terms of the appended claims.

What is claimed is:

1. A sheet processing apparatus comprising:
a curl correcting section including a conveying member configured to convey a sheet, and a pushing shaft configured to push, toward the conveying member, the sheet conveyed by the conveying member, the curl correcting section being capable of adjusting a correction amount of a curl of the sheet by adjusting a pushing amount of the pushing shaft for pushing the conveying member; and
a moving guide section configured to guide the sheet toward a pushing position of the sheet in the conveying member, the moving guide section being configured to move along with a pushing operation of the pushing shaft while maintaining a distance from the pushing shaft at a predetermined distance or smaller such that a conveyance error of the sheet is not caused when the moving guide section guides the sheet.

2. The sheet processing apparatus according to claim 1, wherein the moving guide section moves such that the moving guide section does not interfere with the conveying member.

3. The sheet processing apparatus according to claim 1, wherein the moving guide section turns about a center of the pushing shaft.

4. The sheet processing apparatus according to claim 1, wherein the conveying member is a belt member.

5. The sheet processing apparatus according to claim 1, wherein a sliding member is provided at a portion opposite to the pushing shaft in the moving guide section, the sliding member being rotatable and configured to make contact with the pushing shaft.

6. The sheet processing apparatus according to claim 1 further comprising a fixed guide section configured to guide the sheet toward the moving guide section at a position on an upstream side of the moving guide section in a conveyance direction of the sheet.

7. The sheet processing apparatus according to claim 6, wherein a conveying roller configured to convey the sheet is provided at a downstream end of the fixed guide section in the conveyance direction of the sheet.

8. The sheet processing apparatus according to claim 6, wherein the moving guide section moves forward and backward from the downstream end of the fixed guide section in the conveyance direction of the sheet.

9. The sheet processing apparatus according to claim 1 further comprising a downstream side moving guide section, the downstream side moving guide section being disposed on a downstream side of the pushing position of the sheet in the sheet conveyance direction in the conveying member, and configured to guide the sheet which has passed through the pushing position, the downstream side moving guide section being configured to move along with the pushing operation of the pushing shaft while maintaining a distance from the pushing shaft at a predetermined distance or smaller such that a conveyance error of the sheet is not caused when the moving guide section guides the sheet.

10. An image formation system comprising:
the sheet processing apparatus according to claim 1; and
an image forming apparatus configured to introduce, to the sheet processing apparatus, the sheet on which an image is formed.

11. The image formation system according to claim 10, wherein the image forming apparatus includes a hardware processor configured to control the curl correcting section.

12. The image formation system according to claim 11, wherein the hardware processor controls the curl correcting section based on information relating to a curling state of the sheet that is introduced to the sheet processing apparatus.
